(19) United States
(12) Patent Application Publication
(10) Pub. No.: US 2006/0291032 A1
(43) Pub. Date: Dec. 28, 2006

(54) Driving method of an electrophoretic display with high frame rate and low peak power consumption

(75) Inventors: Guofu Zhou, Best (NL); Jan van de Kamer, Heerlen (NL); Neculai Ailenei, Landgraaf (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/569,178

(22) PCT Filed: Aug. 23, 2004
(86) PCT No.: PCT/IB04/51532

§ 371 Date: Feb. 22, 2006

Related U.S. Application Data
(60) Provisional application No. 60/497,660, filed on Aug. 25, 2003.
(60) Provisional application No. 60/526,186, filed on Dec. 2, 2003.

(51) Int. Cl. G02B 26/00

(52) U.S. Cl. 359/296

(57) ABSTRACT

An image is updated on a bi-stable display (310) such as an electrophoretic display by applying a drive waveform (900,920,940, 960; 1000, 1020,1040, 1060; 1100, 1120, 1140, 1160; 1220, 1240, 1260) with a compensating impulse (C) to at least one pixel (2) in the display. An energy of the compensating impulse depends on the image holding time, and is sufficient to restore the display to an original, pre-drift, brightness level. In one approach, the energy of the compensating impulse is determined as a predetermined function of the image holding time. In another approach, data defining different waveforms for respective different image holding times is provided in respective different look-up tables, and the data from one of the tables is selected according to the image holding time for driving the display. The compensating impulse may be provided in different portions of the drive waveform.

The invention relates generally to electronic reading devices such as electronic books and electronic newspapers and, more particularly, to a method and apparatus for updating an image with improved greyscale accuracy by compensating for image instability.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., U.S., and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in blue liquid.

Other fluids such as air may also be used in the medium in which the charged black and white particles move around in an electric field (e.g., Bridgestone SID2003-Symposium on Information Displays. May 18-23, 2003, - digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, the greyscale accuracy needs to be further improved, in particular, in the region of relatively short image holding times. For example, during a scrolling mode, where the image on the screen is scrolled up or down, or left or right, by the user, image retention is observed because of the increased greyscale error due to strong image instability.

The invention addresses the above and other issues by providing a method and apparatus for compensating image instability and improving greyscale accuracy for a bi-stable device such as an active matrix electrophoretic display. In particular, the time interval between two subsequent image updates on a pixel or on every pixel is considered. This time interval is defined as the image-holding time during which time period the pixel is not addressed or the power on the pixel is substantially zero. Drive waveforms for various optical transitions are made directly based on image holding times. This may be realized by pre-determining the waveforms for various image-holding times and, during an image update period, loading the correct waveform according the holding time of the present image on the pixel. Alternatively, the waveforms for a fixed (usually short) image holding time are pre-determined and a correction function (or table) is used for correcting the effect of brightness drift during the image-holding period on the greyscale accuracy. The correcting impulse may be determined by a curve of brightness variation versus image-holding time, which is usually a function of the characteristic of the ink material. In this way, the greyscale error induced by image instability is significantly reduced and the requirement for the image stability of the ink material becomes less critical. Thus, the invention accommodates material variations, which are unavoidable in the manufacturing process, to improve the image quality seen by the user.

In a particular aspect of the invention, a method for updating an image on a bi-stable display includes determining an image holding time for at least one pixel in the display, determining an energy for a compensating impulse according to the image holding time, and applying a drive waveform including the compensating impulse to the at least one pixel to update the at least one pixel. The energy for the compensating impulse is the integration of the voltage over the pulse duration, e.g., time×voltage level when the voltage is fixed. For simplicity, a pulse-width modulated (PWM) driving scheme is used in the following for describing this invention. In a PWM driving scheme, the energy variation in an impulse is realized by varying the pulse length while the voltage level is substantially constant.

A related electronic reading device and program storage device are also provided.

In the drawings:

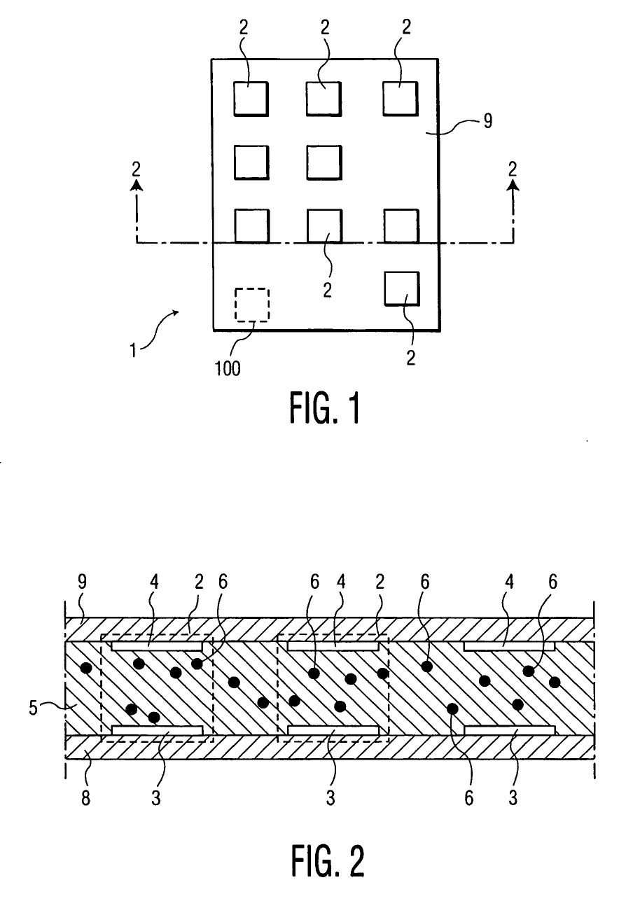

FIG. 1 shows diagramatically a front view of an embodiment of a portion of a display screen of an electronic reading device;

FIG. 2 shows diagramatically a cross-sectional view along 2-2 in FIG. 1;

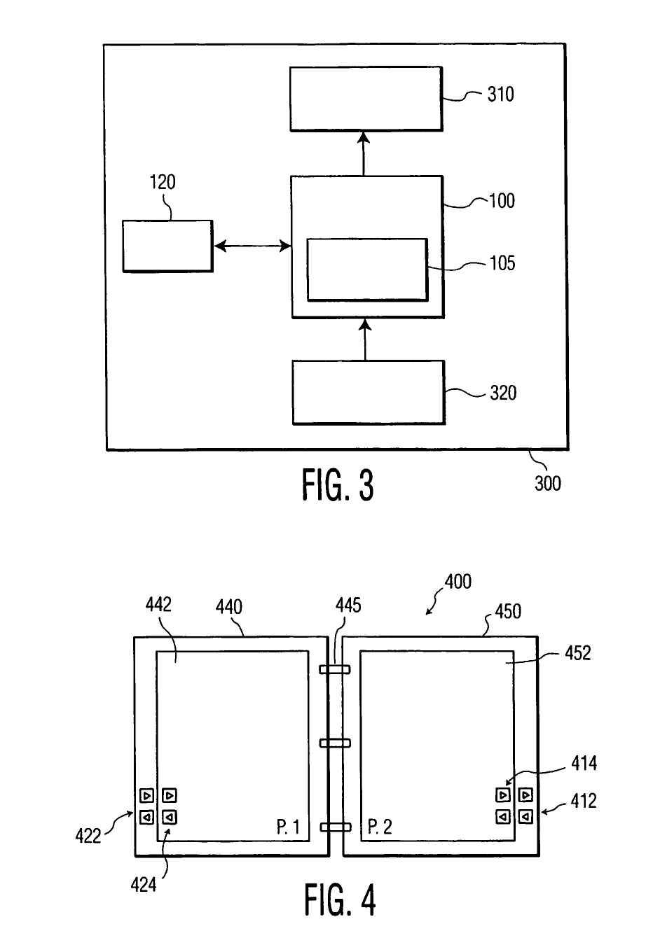

FIG. 3 shows diagramatically an overview of an electronic reading device;

FIG. 4 shows diagramatically two display screens with respective display regions;

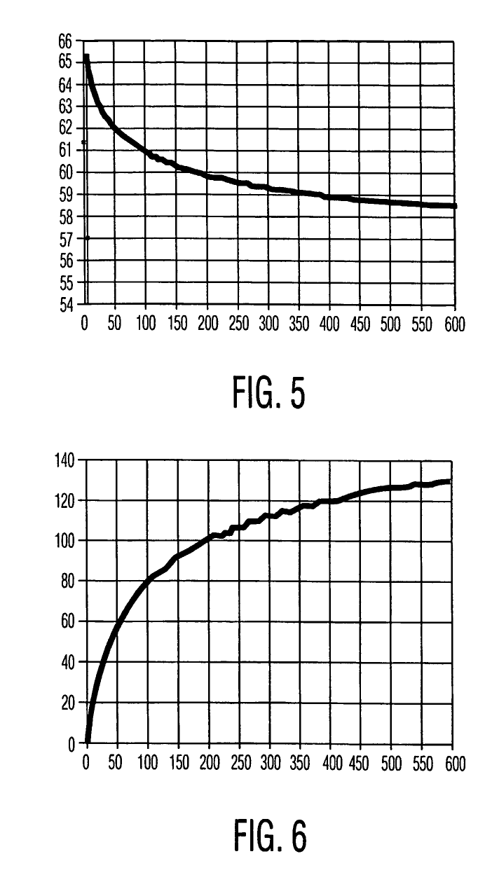

FIG. 5 illustrates a variation in brightness with image holding time directly after addressing to the white state;

FIG. 6 illustrates a variation in compensating impulse time with image holding time for the white state;

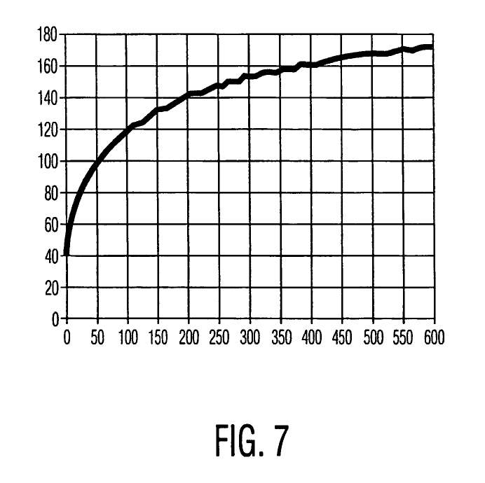

FIG. 7 illustrates a variation in compensating impulse time with image holding time for the initial white state with an over-reset time of 40 ms;

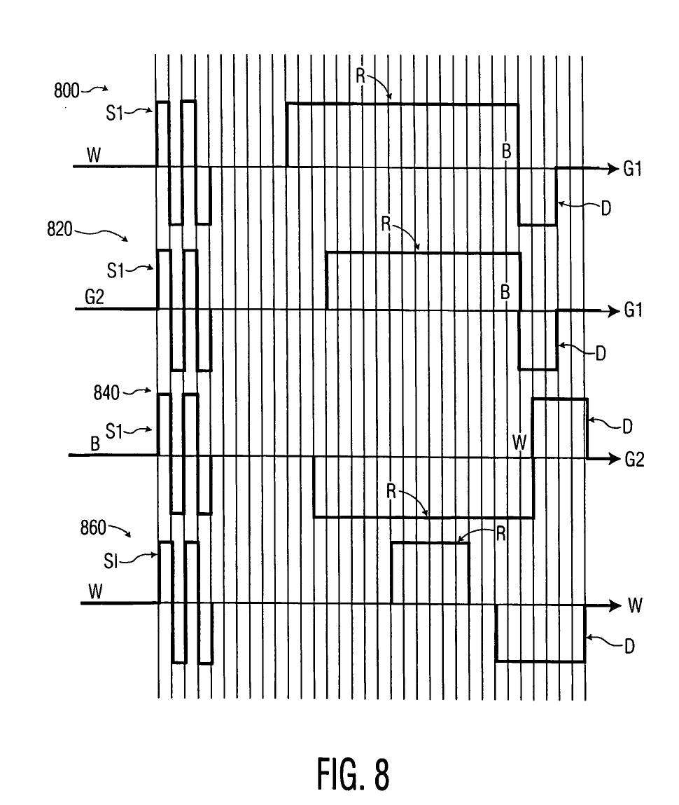

FIG. 8 illustrates example waveforms at a fixed (short) image holding time;

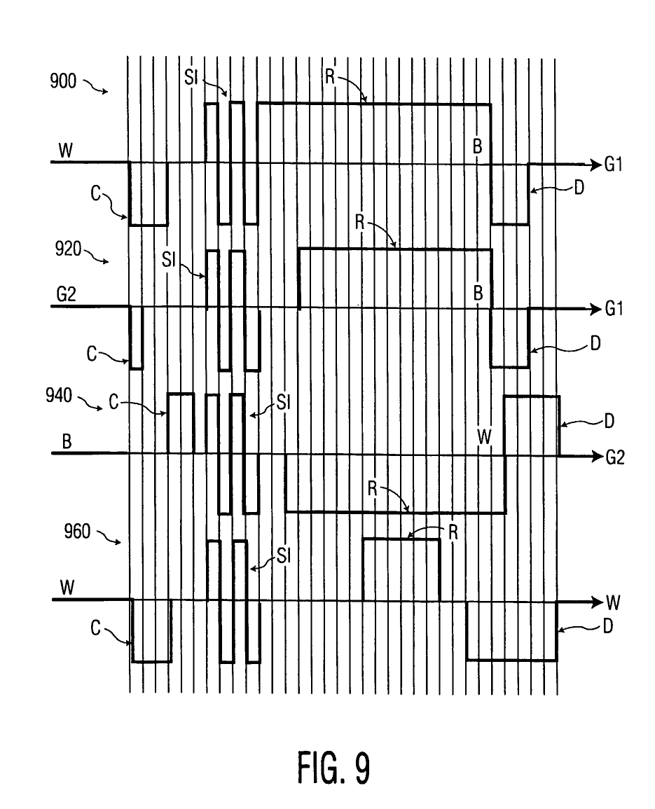

FIG. 9 illustrates example waveforms with a compensating (C) impulse with variable energy according to image holding time that is provided prior to all data signals, according to the invention;

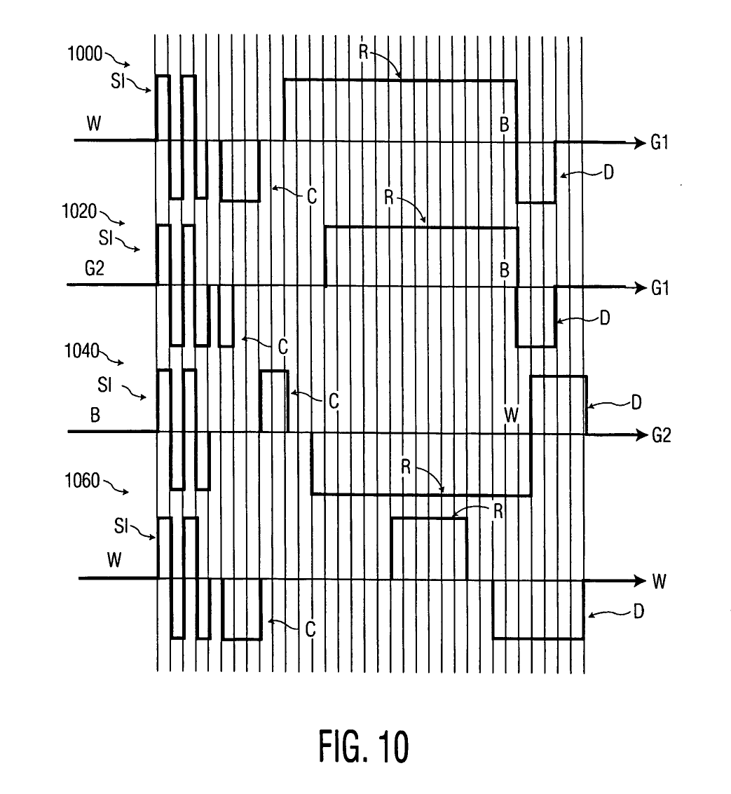

FIG. 10 illustrates example waveforms with a compensating (C) impulse with variable energy according to image holding time that is provided after the first shaking pulses (S1) and prior to reset (R) pulses, according to the invention;

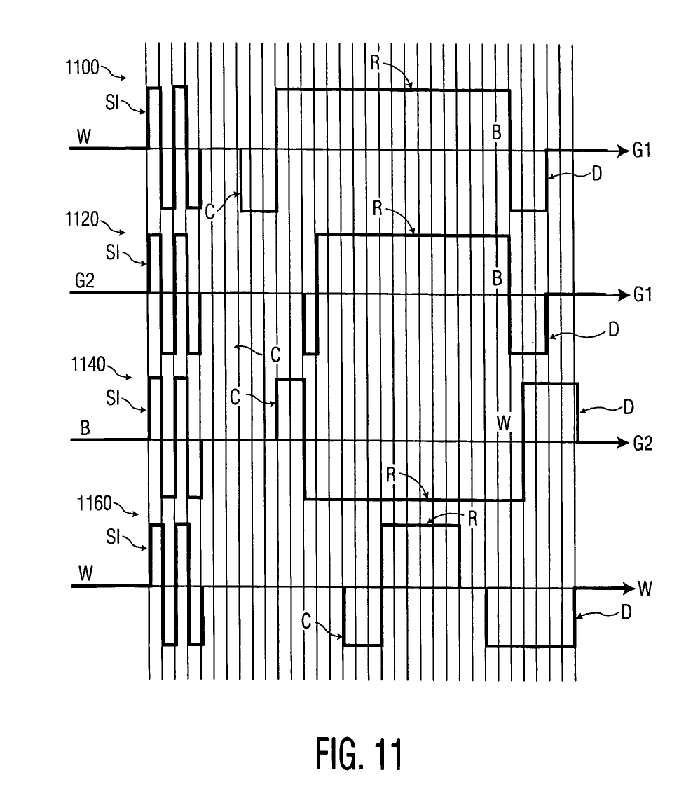

FIG. 11 illustrates example waveforms with a compensating (C) impulse with variable energy according to image holding time that is part of the first signal pulse, according to the invention; and

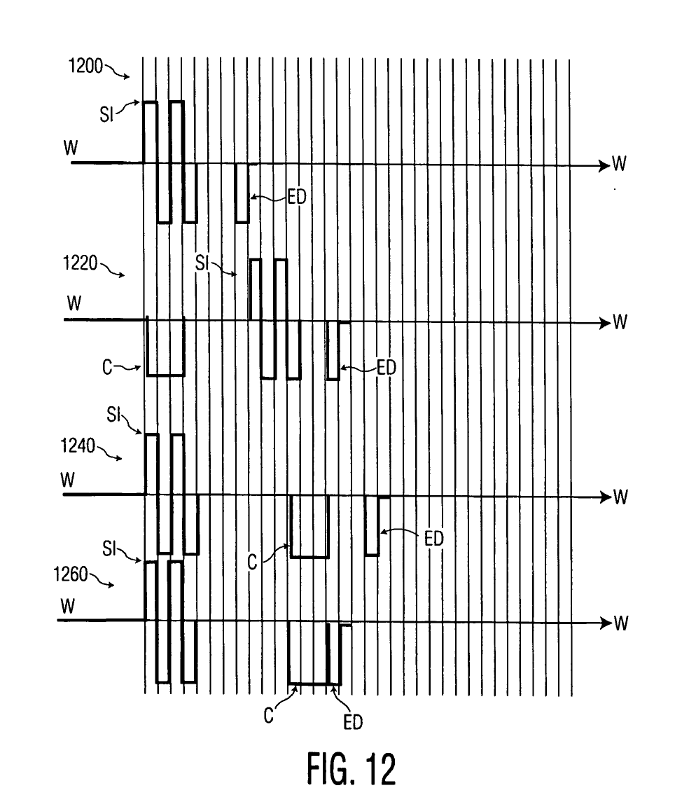

FIG. 12 illustrates example waveforms for a white-to-white transition with a compensating (C) impulse with variable energy, according to the invention.

In all the Figures, corresponding parts are referenced by the same reference numerals.

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element or pixel 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. A drive control 100 controls the potential difference of each picture element 2 to create a desired picture, e.g., images and/or text, in a full display screen. The full display screen is made up of numerous picture elements that correspond to pixels in a display.

FIG. 3 shows diagramatically an overview of an electronic reading device. The electronic reading device 300 includes the control 100, including an addressing circuit 105. The control 100 controls the one or more display screens 310, such as electrophoretic screens, to cause desired text or images to be displayed. For example, the control 100 may provide voltage waveforms to the different pixels in the display screen 310. The addressing circuit provides information for addressing specific pixels, such as row and column, to cause the desired image or text to be displayed. As described further below, the control 100 causes successive pages to be displayed starting on different rows and/or columns. The image or text data may be stored in a memory 120. One example is the Philips Electronics small form factor optical (SFFO) disk system. The control 100 may be responsive to a user-activated software or hardware button 320 that initiates a user command such as a next page command or previous page command. The control 100 may include an ASIC.

The control 100 may execute any type of computer code devices, such as software, firmware, micro code or the like, to achieve the functionality described herein. Moreover, the memory 120 may be a program storage device that tangibly embodies a program of instructions executable by a machine such as the control 100 or a computer to perform a method that achieves the functionality described herein. Such a program storage device may be provided in a manner apparent to those skilled in the art. A computer program product comprising such computer code devices may also be provided in a manner apparent to those skilled in the art.

The control 100 may have logic for periodically providing a forced reset of a display region of an electronic book, e.g., after every x pages are displayed, after every y minutes, e.g., ten minutes, when the electronic reading device is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on- screen buttons 414 and/or hardware buttons 412. Note that the frame 405 around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into two or more display regions arranged, e.g., horizontally or vertically. In any case, the invention can be used with each display region to reduce image retention effects and to improve the smoothness of the image update.

Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column- wise rather than row-wise. It is also possible to have a single display screen that is partitioned into two or more separate display regions.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Image Drift

The bi-stable display, such as the electrophoretic display, had advantages compared to other displays such as LCDs in terms of its high brightness, high contrast ratio, wide view angle and stable image. Additionally, the average power consumption is more than a factor of one hundred lower than with LCDs due to a lower refresh rate enabled by its bi-stability. That is, after completion of an image update, the image substantially holds on the pixel without supplying any voltage pulse. The voltage pulse is only needed during the next image update. It would also be possible to not update/refresh the pixels on which the optical state does not change during next image update, such as in a white-to-white transition, resulting in still lower power consumption. However, in practical electrophoretic displays, it is observed that the optical state drifts away during an image holding period, in particular, in the first 100 seconds directly after the image update.

For example, FIG. 5 illustrates a variation in brightness with image holding time directly after addressing to the white state. The data was experimentally obtained using a prototype active matrix display panel. The horizontal axis indicates image-holding time, in seconds, while the vertical axis indicates white state brightness (L*). As can be seen, the brightness decreases almost exponentially as the holding time increases. An approximate final level is reached after roughly 200 seconds. The difference between the “final” and initial levels can be as large as 6-7L*. In practice, the holding time is variable depending on the usage mode. A drive waveform that is determined based on a fixed holding time may be used, but this approach often results in large greyscale errors. Integration of shaking pulses and over-reset pulses in the drive waveforms significantly improves the greyscale accuracy. Shaking pulses are discussed in co-pending European patent application 02077017.8, entitled “Display device”, docket no. PHNL030441, incorporated herein by reference. Over-reset pulses are discussed in co-pending European patent application 03100133.2, entitled “Electrophoretic display panel”, docket no. PHNL030091, incorporated herein by reference.

The present invention provides a driving technique that compensates for image instability and improves greyscale accuracy for a bi-stable display by considering the image holding time on an individual pixel, a group of pixels, or every pixel. Drive waveforms for various optical transitions are made directly coupled with image-holding times. This may be realized by pre-determining the waveforms for various image-holding times and, during an image update period, loading the correct waveform according the holding time of the present image on the pixel. Alternatively, the waveforms for a fixed (short) image holding time are pre-determined and a correction function or table is used for correcting the effect of brightness drift during the image-holding period on the greyscale accuracy. The correcting impulse may be determined by a curve of brightness variation versus image holding time, which is usually a function of the characteristic of the ink material. In this way, the greyscale error induced by image instability is significantly reduced and/or the requirement for the image-stability of ink material becomes less critical. Image quality is therefore improved while manufacturing costs can be reduced.

### EMBODIMENT 1

In a first embodiment, an image-instability compensating impulse versus image holding time curve is used for recovering or correcting the optical state in the next image transition. The impulse is obtained by measuring the brightness as a function of impulse energy, which pulse tries to bring the present brightness, e.g., white, at the present image holding time to the original/initial level at a substantially zero image holding time, i.e., the level that is obtained directly after the image updating. The minimal impulse to fully restore the brightness is defined as the compensating impulse at this image holding time. The same procedure is repeated for other image-holding times. From these data, a curve of compensating impulse time versus image holding time is generated as schematically plotted in FIG. 6. FIG. 6 illustrates an experimental curve of compensating impulse time versus image holding time for the white state in an active matrix display panel. A substantially constant voltage of −15 V is used in the experiment. The horizontal axis indicates image holding time, in seconds, while the vertical axis indicates the image-instability compensating impulse time in milliseconds (ms). The time period of the compensating impulse increases almost exponentially with the increase in the image holding time, so that a longer correction pulse is required at a longer holding time. In this example and hereafter, pulse-width modulated driving is used for simplicity, although other driving schemes may be used, as discussed further below. The pulse time is adjusted in each impulse to vary the impulse energy while voltage level is substantially constant.

In rail-stabilized driving schemes (e.g., as discussed in the above-identified European patent application 03100133.2), an over-reset pulse is sometimes used to achieve accurate greyscale with a reduced image update time and reduced optical flicker. In such driving schemes, the drive waveforms include reset pulses and greyscale driving pulses. The reset pulse is defined as a voltage pulse that moves particles from their present positions to one of the two extreme positions close to one of the two electrodes, and the greyscale driving pulse is the voltage pulse that sends the display or pixel to the desired final optical state. In such driving schemes, the above measured curve may also be used for compensating for the image instability effect. In this case, the reset pulse may include three parts: standard-reset, over-reset and image-instability correcting reset, as illustrated in FIG. 7 for an initial state of white. FIG. 7 illustrates compensating impulse time versus image holding time for the initial white state in an active matrix display panel with an over-reset time period of 40 ms. As seen, a longer correction pulse is required at a longer holding time. Since the display is already at the white state, the standard reset is now absent. A constant over-reset pulse of 40 ms is used in this example, and a variable image instability correcting reset is introduced as measured based on the data of FIG. 6. The curve of FIG. 7 is obtained by adding 40 ms to the curve of FIG. 6.

To implement the first embodiment, a memory, e.g., memory 120, may store standard drive waveforms at a fixed image-holding time for example in the greyscale update (GU) mode, which waveforms are used for updating greyscale images. The standard drive waveform refers to a drive waveform that is optimized at a fixed image holding time, which holding time is preferably short, e.g., close to zero or a few seconds. The standard drive waveform does not use a compensating impulse according to the invention, and may include, for instance, shaking pulses, a reset pulse and a drive pulse, as discussed further in connection with FIGS. 8-12. The standard drive waveforms at a fixed image-holding time for other update modes, for example for monochrome update (MU) mode, are stored in the memory 120, which waveforms are used for updating monochrome images. Data for functions/curves of the pre-determined compensating impulse for various optical transitions (e.g., such as shown in FIG. 6) can be stored in the same sequences as the standard drive waveforms. For example, for greyscale updates, the greyscale compensating impulse can be stored in the GU mode as a part of the overall greyscale drive waveforms. During an image update, both the standard waveform and the compensation pulse at the corresponding image-holding time are loaded based on the measured image-holding time of present image on the pixel. Similarly, it can be done for other update modes like monochrome update mode.

In fact, the compensating impulse is largely determined by the material property, and is essentially not sensitive to the usage modes. It is therefore further advantageous to store the data for functions/curves of the pre-determined compensating impulse for various optical transitions (e.g., such as shown in FIG. 6) in a single memory (for compensating time or CT) regardless of image updating modes. These data need not be stored separately for different modes, reducing memory requirements. During an image update, both the standard waveform and the compensation pulse at the corresponding image-holding time are loaded based on the measured image-holding time of the present image on the pixel. For example, in a greyscale image update, the standard waveforms are loaded from GU and the compensation pulse at the corresponding image-holding time is loaded from CT based on the measured image-holding time of the present image on the pixel. Similarly, in a monochrome image update, the standard waveforms are loaded from MU, and the compensation pulse at the corresponding image-holding time is loaded from CT based on the measured image-holding time of the present image on the pixel. This can be done for other update modes like monochrome update mode.

A further advantage of this method is to allow one to scale the compensating impulse according to the image holding time. Assuming a basic pulse length for compensating image stability is introduced in a drive waveform, one can obtain a scaling factor vs. image holding time curve according to the measured image holding time curve and the brightness correcting/restoring curve. The scaling factor curve may be stored together with the pre-determined image holding time and can be loaded according to the image holding time on the pixel during an image update. The “basic” or standard compensating impulse is a part of various drive waveforms with a variable pulse length or energy determined by the scaling factor according to the image holding time on the pixel. A reduced memory requirement together with an increased image update efficiency is realized because it is not necessary to separately load the standard drive waveforms and the compensating waveform and the scaling factor is read out when the image holding time is read.

### EMBODIMENT 2

In a second possible embodiment, instead of reading a function/curve that describes curves such as those of FIGS. 6 and 7 to determine a compensating impulse time based on the image holding time, individual look-up-tables (LUTs) may be generated at different image-holding times and stored in memory. The LUTs include data defining different waveforms for respective different image holding times. During an image update period, a selected one of the waveforms is loaded according the holding time of the present image on the pixel, and applied to at least one pixel in the display. The greyscale accuracy may be increased by providing an increased number of LUTs for different holding times, depending on the available memory space.

To illustrate, the curves of FIGS. 5 and 7, for instance, may be used as an aid in determining the data for various LUTs at different image-holding times. Assuming a maximum of eight LUTs may be used, for instance, one of the LUTs may include data for providing the standard drive waveform, with no compensating impulse, and the other seven LUTs may include data for drive waveforms with compensating impulses for seven different image-holding times. In one approach, the LUTs are based on equal, or substantially equal, increments of brightness. For instance, the curve of FIG. 5 can be read at different brightness levels to determine the corresponding image holding times. With the image holding times obtained at equal brightness increments, e.g., increments of 1L*, a curve of compensating impulse time versus image holding time, such as in FIG. 7, can then be read to obtain compensating impulse times. Example results are as follows.

| Brightness | Image holding | Compensating impulse |
|---|---|---|
| level (L*) | time (sec.) | time (msec.) |
| 65 | 0 | 40 |
| 64 | 15 | 60 |
| 63 | 30 | 85 |
| 62 | 50 | 95 |
| 61 | 100 | 120 |
| 60 | 180 | 138 |
| 59 | 400 | 160 |
| 58.6 | 600 | 170 |

The above eight points are provided as an example only. Fewer or more points can be used as desired. Data for additional tables can be obtained by interpolating other tables. Moreover, data for determining compensating impulse energies when pulse width modulation is not used may be obtained analogously. For instance, a curve similar to FIG. 7 may be used where the vertical axis indicates energy. A corresponding compensating impulse can be provided based on the impulse shape such that the integral of voltage over time sums to the desired energy.

FIGS. 8 through 12, discussed below, illustrate example time-domain waveforms that provide a compensating impulse as discussed above.

FIG. 8 illustrates example waveforms for a fixed image holding time, which is preferably short, e.g., a few seconds. Waveforms 800, 820, 840 and 860 provide transitions from white (W) to dark grey (G1), light grey (G2) to dark grey (G1), black (B) to light grey (G2), and white (W) to white (W), respectively. S1 denotes a first-set of shaking pulses, R denotes a reset pulse, and D denotes a driving pulse. Each shaking pulse represents energy sufficient to release the particles at their current positions but insufficient to move the particles from their current positions to one of the two extreme positions, close to the two electrodes. In this example, no compensating impulses are used. The overall waveforms 800, 820, 840 and 860 may be considered to be drive waveforms, also referred as the standard drive waveforms for various image transitions.

FIG. 9 illustrates example waveforms with a compensating (C) pulse with variable energy according to image holding time, that is provided prior to all data signals, according to the invention. Drive waveforms 900, 920, 940 and 960 provide transitions from white (W) to dark grey (G1), light grey (G2) to dark grey (G1), black (B) to light grey (G2), and white (W) to white (W), respectively. S1 denotes a first shaking pulse, R denotes a reset pulse, D denotes a driving pulse, and C denotes a compensating impulse. Note that the compensating impulses can have different durations and polarities. In the example shown, the compensating impulses are provided before all data signals, including the first shaking pulse (S1). In the waveforms 900 and 920, “B” indicates that the black state has been achieved at the end of the reset pulse (R). In the waveform 940, “W” indicates that the white state has been achieved at the end of the reset pulse (R). The polarity of the compensating impulse is opposite to that of the reset pulse, but the same as that of the drive (D) pulse. It is advantageous to locate the compensating impulse as indicated because the original/initial brightness level at substantially zero image holding time is first substantially restored from the current image holding time prior to the application of the standard drive waveforms, which ensures a well-defined initial reference state, thus increasing the greyscale accuracy.

FIG. 10 illustrates example waveforms with a compensating (C) pulse with variable energy according to dwell time that is provided between first shaking pulses (S1) and reset (R) pulses, according to the invention. Drive waveforms 1000, 1020, 1040 and 1060 provide transitions from white (W) to dark grey (G1), light grey (G2) to dark grey (G1), black (B) to light grey (G2), and white (W) to white (W), respectively. S1 denotes a first shaking pulse, R denotes a reset pulse, D denotes a driving pulse, and C denotes a compensating impulse. In the waveforms 1000 and 1020, “B” indicates that the black state has been achieved at the end of the reset pulse (R). In the waveform 1040, “W” indicates that the white state has been achieved at the end of the reset pulse (R). The polarity of the compensating impulse is opposite to that of the reset pulse, but the same as that of the drive (D) pulse. It is advantageous to locate the compensating impulse as indicated because the image history on the pixel is first removed by applying the shaking pulses (S1), after which the original/initial brightness level at substantially zero image holding time is substantially restored from the current image holding time prior to the application of the second part of the standard drive waveforms. This construction may further increase the greyscale accuracy because not only a well-defined initial reference state is guaranteed but also the image history on the pixel is minimized.

FIG. 11 illustrates example waveforms with a compensating (C) pulse with variable energy according to dwell time that is part of the first signal pulse, according to the invention. Drive waveforms 1100, 1120, 1140 and 1160 provide transitions from white (W) to dark grey (G1), light grey (G2) to dark grey (G1), black (B) to light grey (G2), and white (W) to white (W), respectively. S1 denotes a first shaking pulse, R denotes a reset pulse, D denotes a driving pulse, and C denotes a compensating impulse. In the waveforms 1100 and 1120, “B” indicates that the black state has been achieved at the end of the reset pulse (R). In the waveform 1140, “W” indicates that the white state has been achieved at the end of the reset pulse (R).

In the waveforms of FIGS. 9 and 10, the compensating impulse was applied as a distinct pulse. In contrast, in FIG. 11, the compensating impulse is directly adjacent to the first signal pulse, i.e., the reset pulse (R). For example, in the waveform 1100, the compensating impulse (C) has a negative polarity and is adjacent to the reset pulse (R), which has a positive polarity. The same holds true for the waveforms 1120 and 1160. In the waveform 1140, the compensating impulse (C) has a positive polarity and is adjacent to the reset pulse (R), which has a negative polarity. The polarity of the compensating impulse is opposite to that of the reset pulse, but the same as that of the drive (D) pulse. It is advantageous to locate the compensating impulse as indicated because the image quality is further improved by reducing the time interval between the compensating impulse and the reset pulse.

FIG. 12 illustrates example drive waveforms 1200, 1220, 1240 and 1260 for white-to-white transitions. Waveform 1200 is a standard waveform at a fixed image holding time that is provided for comparison. Waveform 1220 includes a compensating (C) impulse with variable energy according to image holding time that is prior to the data signal, e.g., shaking pulses (S1) and an extreme drive (ED) pulse. An extreme drive pulse refers to a voltage pulse representing energy sufficient to move particles from the present position or state to a final state, which is one of the extreme states. An extreme drive pulse can be used with, or in place of, a reset pulse. Moreover, the extreme drive pulse can have a duration that is sufficient, or more than sufficient, to move particles from the present state to the final, extreme state. Thus, the extreme drive pulse duration is analogous to the reset or over-reset pulse duration. Waveform 1240 includes a compensating (C) impulse with variable energy according to image holding time that is between the shaking pulses (S1) and the ED pulse. Waveform 1260 includes a compensating (C) impulse with variable energy according to image holding time that is after the shaking pulses (S1) and immediately prior to, and adjacent to, the ED pulse.

This embodiment illustrates that the standard waveforms for the image transitions without substantial optical state changes on the pixel can be simplified to, e.g., a single polarity waveform. This will further reduce the optical flicker during an image update. Again, a compensating (C) pulse with variable energy according to the image holding time is part of the drive waveform and provided at various time moments in the waveform as discussed in FIGS. 9-11, according to the invention. Here, as indicated in waveforms 1220, 1240 and 1260, the polarity of the compensating impulse is the same as that of the extreme drive (ED) pulse.

The polarity of a compensating impulse (C) is selected such that the particles in the display are able to move towards the direction, resulting in the initial/original optical state that is obtained during previous image update at a substantially zero image holding time, regardless of the polarity of the pulses in the subsequent standard drive waveform.

It is emphasized that the time intervals between any two subsequent pulses can be substantially equal to zero as an advantage of shorter total image update time. To measure the image holding time on a pixel, a timer may be introduced on the pixel. The timer automatically starts counting directly after the image update is complete and the elapsed time since last image update on the pixel is read, which is used during the subsequent image update for loading the correct compensating impulse. In the mean time, the timer can be reset to zero and start new counting after the next update. This process can be repeated. Although it is beneficial to count the image holding time for every individual pixel, it is, in practice, possible to count the image holding time for a single pixel on the display, and the timer information can be used for updating the entire display or a portion of the display. Note that, in the above examples, pulse-width modulated (PWM) driving is used for illustrating the invention, i.e., the pulse time is varied in each waveform while the voltage amplitude is kept constant. However, the invention is also applicable to other driving schemes, e.g., based on voltage modulated driving (VM), where the pulse voltage amplitude is varied in each waveform, or combined PWM and VM driving. When VM driving or combined VM and PWM driving is used, the compensating impulse is selected such that the energy involved in the compensating impulse is just enough to fully restore the brightness to the initial level obtained directly after update. This invention is also applicable to color bi-stable displays. Also, the electrode structure is not limited. For example, a top/bottom electrode structure, honeycomb structure or other combined in- plane-switching and vertical switching may be used. Moreover, the invention may be implemented in passive matrix as well as active matrix electrophoretic displays. In fact, the invention can be implemented in any bi-stable display that does not consume power while the image substantially remains on the display after an image update. Also, the invention is applicable to both single and multiple window displays, where, for example, a typewriter mode exists.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for updating an image on a bi-stable display, the method comprising:
determining an image holding time for at least one pixel (2) in the bi-stable display (310);
determining an energy with which to provide a compensating impulse (C) according to the image holding time; and
applying a drive waveform (900, 920, 940, 960; 1000, 1020, 1040, 1060; 1100, 1120, 1140, 1160; 1220, 1240, 1260) including the compensating impulse to the at least one pixel to update the at least one pixel.

2. The method of claim 1, wherein:
the bi-stable display comprises an electrophoretic display.

3. The method of claim 1, wherein:
the determining of the energy comprises determining the energy with which to provide the compensating impulse as a predetermined function of the image holding time.

4. The method of claim 3, wherein:
the predetermined function of the image holding time is determined by measuring brightness (L) as a function of impulse energy for different image holding times.

5. The method of claim 1, wherein:
the determining of the image holding time for the at least one pixel comprises measuring the image holding time for the at least one pixel.

6. The method of claim 1, wherein:
a polarity of the compensating impulse is selected to cause particles in the bi-stable display to move in a direction resulting in an initial optical state of the at least one pixel.

7. The method of claim 1, wherein:
the compensating impulse (C) is provided in the drive waveform prior to all data pulses (S1, R, D, ED).

8. The method of claim 1, wherein:
the compensating impulse (C) is provided in the drive waveform following a shaking pulse (S1), and prior to a reset pulse (R and extreme drive pulse (ED).

9. The method of claim 1, wherein:
the compensating impulse (C) is provided in the drive waveform immediately preceding, and adjacent to, an extreme drive pulse (ED).

10. The method of claim 1, further comprising:
providing data defining different waveforms for respective different image holding times;
wherein the applying the drive waveform comprises selecting one of the different waveforms to apply to the at least one pixel based on the determined image holding time.

11. The method of claim 10, further comprising:
storing the data defining the different waveforms in respective different look-up tables (120).

12. The method of claim 10, wherein:
the data defining the different waveforms includes data for scaling a standard compensating impulse according to the determined energy.

13. The method of claim 10, wherein:
the providing data defining different waveforms comprises providing data for substantially equal increments of brightness (L) associated with the respective different image holding times.

14. A program storage device tangibly embodying a program of instructions executable by a machine to perform a method for updating an image on a bi-stable display, the method comprising:
determining an image holding time for at least one pixel (2) in the bi-stable display (310);
determining an energy with which to provide a compensating impulse (C) according to the image holding time; and
applying a drive waveform (900, 920, 940, 960; 1000, 1020, 1040, 1060; 1100, 1120, 1140, 1160; 1220, 1240, 1260) including the compensating impulse to the at least one pixel to update the at least one pixel.

15. A display device, comprising:
a bi-stable display (310, 400); and
a control (100) for updating an image on the bi-stable display by determining an image holding time for at least one pixel (2) in the bi-stable display, determining an energy with which to provide a compensating impulse (C) according to the image holding time, and applying a drive waveform (900, 920, 940, 960; 1000, 1020, 1040, 1060; 1100, 1120, 1140, 1160; 1220, 1240, 1260) including the compensating impulse to the at least one pixel to update the at least one pixel.

16. The display device of claim 15, wherein:
the bi-stable display comprises an electrophoretic display.

17. The display device of claim 15, wherein:
the control determines the energy with which to provide the compensating impulse as a predetermined function of the image holding time.

18. The display device of claim 17, wherein:
the predetermined function of the image holding time is determined by measuring brightness (L) as a function of impulse energy for different image holding times.

19. The display device of claim 15, further comprising:
providing data defining different waveforms for respective different image holding times;
wherein the applying the drive waveform comprises selecting one of the different waveforms to apply to the at least one pixel based on the determined image holding time.

20. The display device of claim 19, wherein:
the providing data defining different waveforms comprises providing data for substantially equal increments of brightness (L) associated with the respective different image holding times.

21. A control (100) comprising first means for determining an image holding time for at least one pixel (2) in a bi-stable display, second means for determining, according to the image holding time, an energy of a compensating impulse (C) and third means for applying a drive waveform (900, 920, 940, 960; 1000, 1020, 1040, 1060; 1100, 1120, 1140, 1160; 1220, 1240, 1260) including the compensating impulse to the at least one pixel to update the at least one pixel.
